(19) United States
(12) Patent Application Publication
(10) Pub. No.: US 2025/0224019 A1
(43) Pub. Date: Jul. 10, 2025

(54) CHAIN BLOCK LOCK

(71) Applicant: THIELE GMBH & CO. KG, Iserlohn (DE)

(72) Inventors: Burkard SCHERF, Bergkamen (DE); Janis QUINTING, Menden (DE)

(21) Appl. No.: 18/698,947

(22) PCT Filed: Sep. 28, 2022
(86) PCT No.: PCT/DE2022/100723

§ 371 Date: Apr. 5, 2024

(30) Foreign Application Priority Data
Oct. 6, 2021 (DE) 10 2021 125 975.4

(51) Int. Cl. F16G 15/04

(52) U.S. Cl. CPC F16G 15/04

(57) ABSTRACT

A chain block lock for connecting two chain ends, wherein the block lock has two elongated block lock halves, which extend with their respective longitudinal direction in the chain length direction and when plugged one into the other have a receptacle space for receiving the chain ends, wherein one block lock half has a widening at an upper edge on both sides, which extends over at least 80%, or 90% of the length of the block lock half.

### RELATED APPLICATIONS

The present application is a National Phase of International Application Number PCT/DE2022/100723, filed Sep. 28, 2022, and claims priority of German Application Number 10 2021 125 975.4 filed Oct. 6, 2021.

### FIELD

The present disclosure relates to a chain block lock for connecting two chain ends.

### BACKGROUND

Chain block locks are used for connecting two chain ends. The chain block lock is itself produced from a metallic material, such as steel. Such chains and chain block locks are used in conveyor technology or mining technology. They are used for transmitting traction forces of multiple kilonewtons. The chains are able to run in a side. The chains are driven via sprockets, which apply a corresponding traction force to the chains. A generic chain block lock is described, for example, from DE 10 2015 117 860 A1, the content of the disclosure of which is incorporated.

Chains are able to be optimized with respect to their force transmission. A chain block lock itself is able to represent a weak point in a respective chain strand.

### SUMMARY

The object of the present disclosure is therefore to provide a chain block lock with respect to its traction force to be transmitted and in a structurally simple manner.

The above-mentioned object is achieved in a chain block lock.

The above-mentioned chain block lock for connecting two chain ends has two elongated block lock tabs. The longitudinal direction of each block extends in the chain longitudinal direction of the chain ends to be connected by the block lock. If both block lock halves are plugged together, a receptacle space is thus formed for receiving the chain ends, such as a respective terminal chain link of the chain ends.

According to the present disclosure, the chain block lock is distinguished in that one block lock half has a widening at an upper edge on both sides, which extends over at least 80%, to 90%, of the length of the block lock half and protrudes laterally beyond the respective side.

The effect of widening in only one block lock half is sufficient to significantly increase the traction force to be transmitted by the chain block lock half.

The structural height of the chain block lock is not increased in relation to a comparable chain block lock. The greater width transverse to the chain direction due to the widening is able to be neglected, or is to be neglected in the respective chain strand due to the greater outer width of horizontal chain lengths of the chain. At the same time, the chain block lock is able to run in a sprocket, since the widening at the upper edge is also formed at the same time on the outer block lock half and is thus also protruding on the sprocket on the outside in the radial direction, so that no modifications to existing chain drives are necessary. Secure assembly is also provided, since the outside of the chain block lock is due to the widening.

The fact that at least 80%, or 90%, or the entire length of the block lock half and thus also the block lock has the widening offers the advantage that the widening is present at least in the longitudinal direction of the receptacle space and protruding slightly beyond the receptacle space in the longitudinal direction. A cross section in the area of the tabs or legs of the block lock halves is thus reinforced by the widening.

The chain block lock otherwise has a constant width in the present disclosure. The width extends transversely to the chain longitudinal direction. The width also extends transversely to the height of the block lock.

The width of the widening is able to be 10% to 30% or 15% to 25% greater than the width of the chain block lock. For example, the width of the chain block lock itself is able to be 46 mm. The width of the widening is then able to be 57 mm, for example. This corresponds to an approximately 20% greater width of the widening than the width of the chain block lock.

In the present disclosure, the wall of the chain block lock or the block lock half merges with an inner radius from the constant wall thickness or width into the widening. In this way, a course of tension results. The cross section is able to be used in comparison to the cross-sectional course of the upper tip of the teeth of a sprocket. These are ground off, if not from the beginning due to design and manufacturing, but due to the tribological effect over the period of time of the use, and have an outer radius. This is able to be complementary to the inner radius. In this way, a maximum of existing cross-sectional area is provided in this area to the chain block lock, without the lateral access becoming too large in addition.

In the present disclosure, the widening has a wavy course in the longitudinal direction, and ensures that an increased traction force is transmitted in the longitudinal direction in the area of the tab or the receptacle space. A wave peak is thus to be registered in the area of the receptacle space, at the height of the block lock. The wave shape runs out as a wave valley toward the ends of the chain block lock. The tensions running in the respective block lock half or widening are therefore transmitted in turn in the direction of a middle position with respect to the height.

Due to a coupling of the respective terminal chain link, the inner area of the rounding of the link presses against an inner area of the rounding here. The force flow in the chain block lock is thus optimized.

In the present disclosure, the receptacle space is able to be formed in two receptacle spaces separate from one another. This is produced by a middle web. This middle web offers two advantages. On the one hand, the respective terminal chain link is able to be separately inserted into the chain block lock by an installer. The middle web prevents a constriction in the area of the receptacle space when a traction force is applied to the chain block lock.

The chain block lock is locked together at its end faces. For example, the chain block lock is able to be pivotable. This means that a pivot axis is present at one end face. The chain block lock is able to be folded open and the chain ends are able to be inserted. A locking bolt is then able to be inserted on the opposite side of the chain block lock. The respective end faces are able to be intermeshed like a comb in a formfitting manner. When the chain block lock is closed, additional locking means are able to be provided, such as screws, lock bolts, or the like. The chain block lock is able to be designed according to DE 197 43 025 C1 and DE 20 2019 104 163 U1, however, the content of the disclosure of which is also incorporated.

### BRIEF DESCRIPTION OF THE DRAWINGS

Further advantages, features, and properties of the present disclosure of the subject matter of the following description. The schematic figures serve for easier comprehension of the present disclosure. In the figures:

FIG. 1 shows a chain block lock having two receptacle spaces in a side view according to the present disclosure,

FIG. 2 shows a chain block lock in a perspective view according to the present disclosure,

FIG. 3 shows the chain block lock according to FIG. 1 in a front view according to the present disclosure,

FIG. 4 shows the chain block lock according to FIG. 1 IV-IV in a cross-sectional view according to the present disclosure,

FIG. 5 to FIG. 7 show a second design variant of the chain block lock according to the present disclosure in a side view, perspective view, and front view, respectively.

### DETAILED DESCRIPTION

In the figures, the same reference signs are used for identical or similar components, even if a repeated description is omitted for reasons of simplification.

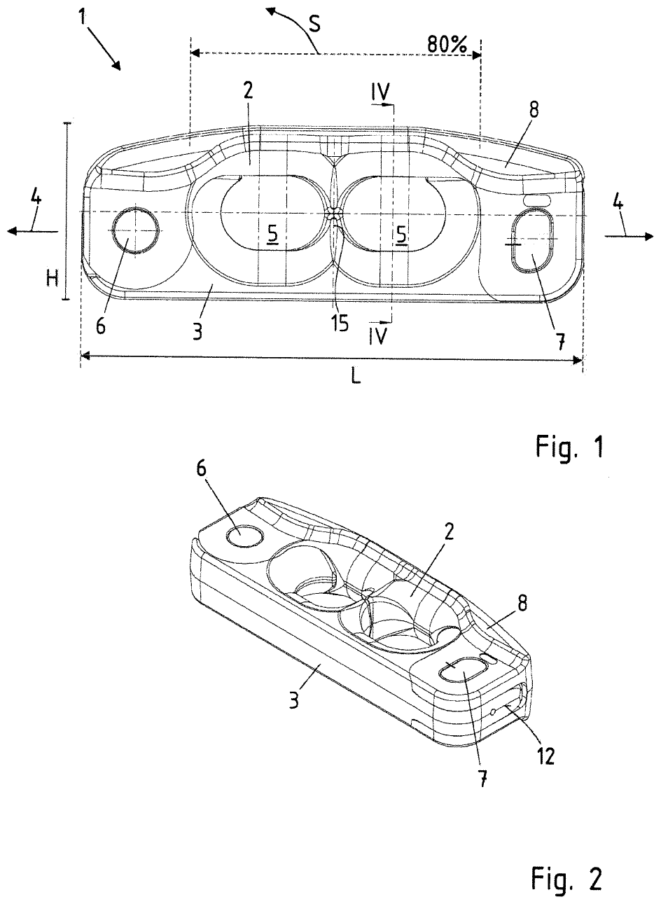

FIG. 1 shows the block lock 1 according to the present disclosure in a side view. The block lock 1 has an upper block lock half 2 and a lower block lock half 3. A chain longitudinal direction 4 is not shown in more detail, but rather is indicated by a respective arrow. The respective longitudinal extension of a block lock half 2, 3 then also extends in the chain longitudinal direction. Two receptacle spaces 5 are shown, in which chain links (not shown in more detail) of the respective chain ends are inserted in order to be connected to one another via the chain block lock. A bolt 6 is inserted on the left with respect to the image plane. The bolt 6 forms an axis of rotation at the same time. The upper block lock half 2 is able to execute a pivot movement in the pivot direction S. On the opposite side, therefore on the right with respect to the image plane, a locking element 7 is inserted, which couples the two block lock halves 2, 3 with one another. Further security elements, such as register pins or the like (not shown in more detail), are able to be used.

According to the present disclosure, a widening 8 is formed. The widening 8 extends, which is apparent in FIG. 2, over the entire length L of the chain block lock 1. The widening 8 is at least to be formed such that it extends over 80% or 90% of the length L. This is shown by the dashed line with the marker 80%. The widening 8 is formed protruding beyond the receptacle spaces 5 in the longitudinal direction. The widening 8 has a wavy course over the longitudinal course. A wave peak is formed here in the longitudinal direction approximately in the middle of the chain block lock 1. The widening 8 extends toward the ends in the form of a wave valley. The course of tension is able to be guided in the direction toward the middle with respect to the height H of the chain block lock 1.

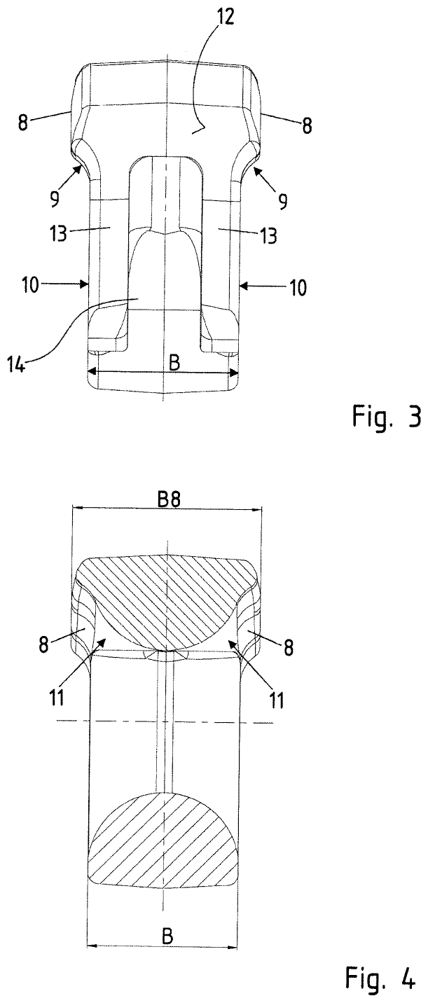

According to FIG. 3 and FIG. 4 the widening 8 is formed protruding on both sides. Otherwise, the chain block lock 1 has a constant width B. From the constant width B, the wall merges into the widening 8 with an inner radius 9. The widening 8 protrudes on both sides 10. According to the cross-sectional view in FIG. 4, the width B8 in relation to the width B is formed 10% to 30%, or 15% to 25% greater. An optimum with respect to the resulting force flux has resulted here. FIG. 2 and FIG. 3 furthermore show at the end face 12 that the block lock halves 2, 3 are locked to one another at their ends and intermesh here like a comb. The upper block lock half 2 encloses a middle web 14 of the lower block lock half 3 on the outside here with two fork-like extensions 13.

The two receptacle spaces 5 are also separated from one another in FIG. 1 by a middle web 15.

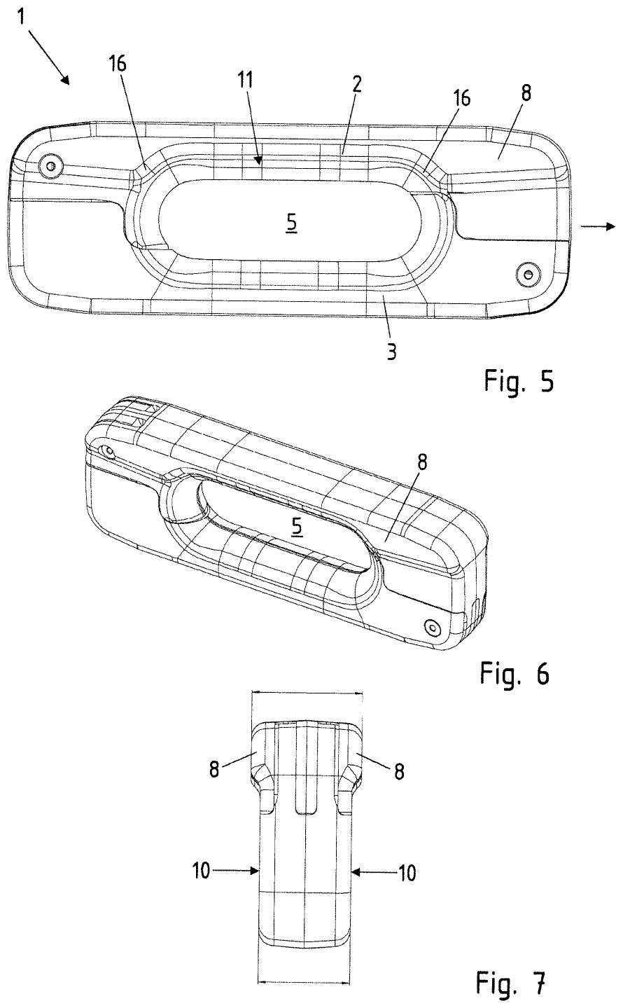

FIG. 5 to FIG. 7 show a second embodiment variant, similar to the first. However, a continuous receptacle space 5 is formed here. One chain link is inserted therein from each side. The widening 8 also extends here over the entire length L of the block lock 1 and protrudes on both sides 10. The block lock halves 2, 3 are also formed in the chain longitudinal direction 4 with their longitudinal direction. The chain block lock 1 is not designed to be foldable in this case, but rather is able to be formed by two separate block lock halves 2, 3, which are able to be mirror symmetrical to one another. The block lock halves 2, 3 are inserted one inside the other and locked with one another. According to the present disclosure, the widening 8 is also formed wavy over the longitudinal course here. The widening 8 thus merges at the transition area 16 from the receptacle space 5 to the end of the block lock 1 in each case in a middle of the chain block lock 1. The force flow is again formed optimized from the respective web area 11 in this way.

1-8. (canceled)

9. A chain block lock configured to connect two chain ends, comprising:
two elongated block lock halves configured to be connected to each other, and extending in a longitudinal direction along a chain length direction, wherein the two elongated block lock halves, in a connected configuration, comprise a receptacle space to receive the two chain ends;
a bolt inserted on one end of the chain block lock in the longitudinal direction, the bolt configuring a pivot axis between the two elongated block lock halves; and
a locking element inserted on an opposite end of the chain block lock in the longitudinal direction, the locking element coupling together the two elongated block lock halves,
wherein only one block lock half of the two elongated block lock halves comprises a widening at an upper edge on both of the end and the opposite end, the widening extending over at least 80% of a length of the one block lock half in the longitudinal direction.

10. The chain block lock according to claim 9, wherein the chain block lock comprises a constant width.

11. The chain block lock according to claim 9, wherein a wall of the chain block lock merges in cross section with an inner radius into the widening.

12. The chain block lock according to claim 9, wherein the widening extends over an entire length of the chain block lock.

13. The chain block lock according to claim 9, wherein a width of the widening is 10% to 30% greater in relation to a width of the chain block lock.

14. The chain block lock according to claim 9, wherein the widening comprises a wavy course in the longitudinal direction.

15. The chain block lock according to claim 9, further comprising a middle web separating the receptacle space into two receptacle spaces.

16. The chain block lock according to claim 9, wherein the two elongated block lock halves are configured to lock with one another at respective end faces.

17. The chain block lock according to claim 9, wherein the widening extends over 90% of the length of the one block lock half.

18. The chain block lock according to claim 9, wherein a width of the widening is 15% to 25% greater in relation to a width of the chain block lock.
